(19) United States
(12) Patent Application Publication
(10) Pub. No.: US 2007/0079718 A1
(43) Pub. Date: Apr. 12, 2007

(54) Microwave fixing toner on a print

(76) Inventors: Knut Behnke, Flintbek (DE); Hendrik Moeller, Hamdorf (DE); Frank-Michael Morgenweek, Kiel (DE); Domingo Rohde, Kiel (DE); Detlef Schulze-Hagenest, Molfsee (DE)

Correspondence Address: PATENT LEGAL STAFF, EASTMAN KODAK COMPANY, 343 STATE STREET, ROCHESTER, NY, 14650-2201, US

(21) Appl. No.: 10/570,572

(22) PCT Filed: Sep. 13, 2004
(86) PCT No.: PCT/US04/29973

§ 371 Date: Oct. 4, 2006

(30) Foreign Application Priority Data
Sep. 18, 2003 (DE) 103 43 708.8

(51) Int. Cl. B41F 23/04

(52) U.S. Cl. 101/487

(57) ABSTRACT

Fixing a toner to a print by heating by a microwave device and including a power source, in which the print is passed through a resonator chamber of the microwave device, in which the microwave power in the resonator chamber is set by at least one element in the resonator chamber, with the power delivered to the microwave device from the power source being constant.

### FIELD OF THE INVENTION

The invention concerns microwave fixing toner on a print where microwave power is set by an element in the microwave resonator chamber, and the power to the microwave device is constant.

### BACKGROUND OF THE INVENTION

A variety of methods are known for fixing toner on a print. The method of rolling a heatable fixer roller with pressure along a print and, in this way, achieving effective bonding of the toner to the print by the action of pressure and heat, is widespread. Contactless methods are also known, in which fixing of the toner on the print is achieved without a force effect on the print. Microwave radiation or infrared radiation is used for this purpose. A microwave device with a magnetron is used, in particular, for the generation of microwaves during the use of microwave radiation. The print is exposed to the microwave field generated by the microwave device for fixing of the toner on the print. The microwave field exerts a certain energy here on the print and toner. Especially in digital printers, in which prints with different basis weights are used, it is advantageous to vary the microwave energy acting on the print during a change in print, in order to guarantee proper fixing.

### SUMMARY OF THE INVENTION

One task of the invention is to guarantee appropriate fixing of the toner on a print. Another task of the invention is to lengthen the service life of a microwave device, especially a magnetron. Another task of the invention is to increase the reliability of a microwave device.

Accordingly, toner is fixed on a print by a method for fixing toner on a print (1) by heating by a power source including microwave device (20), in which print (1) is passed through a resonator chamber (3) of microwave device (20), the method comprising setting the microwave power in resonator chamber (3) by at least one element (4) in the resonator chamber (3), and maintaining delivered power by the power source to microwave device (20) constant.

### BRIEF DESCRIPTION OF THE DRAWINGS

Examples of the invention are described below in detail with reference to the figures wherein:

FIG. 1 is a block diagram of a circuit of one embodiment of the invention;

FIG. 2 shows a schematic front view of a resonator chamber of a microwave device with an element for tuning the resonance state;

FIG. 3a shows a schematic side view according to FIG. 2, in which the element has a first angle position; and

FIG. 3b shows a schematic side view according to FIG. 2, in which the element has a second angle position.

### DETAILED DESCRIPTION OF THE INVENTION

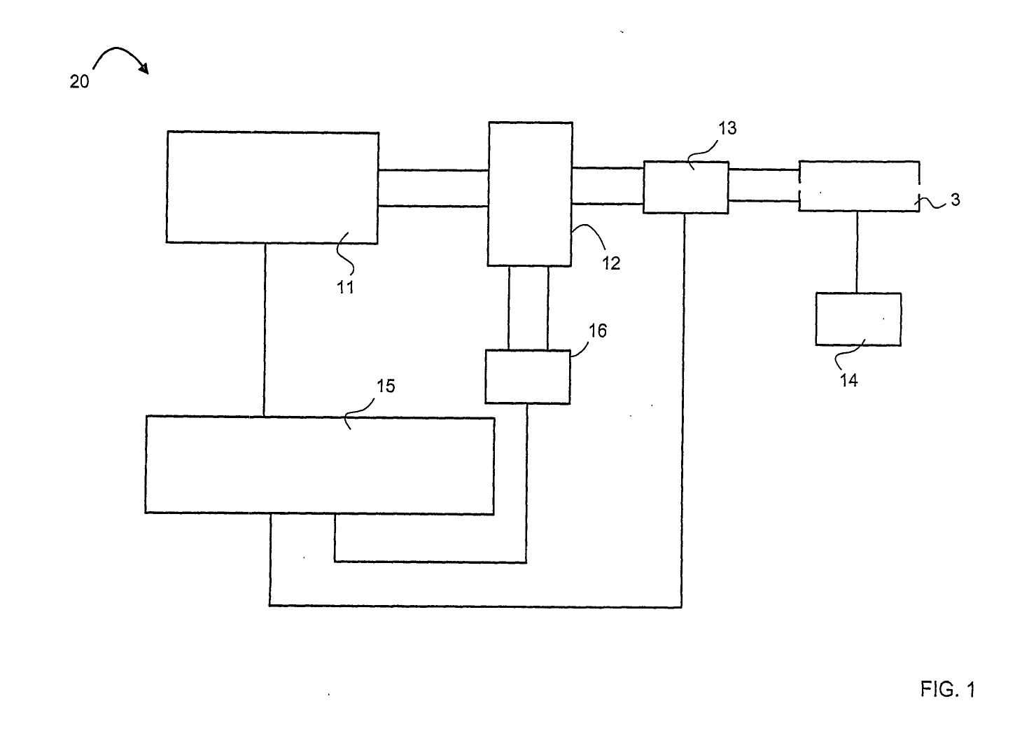

FIG. 1 shows a block diagram of a circuit of one embodiment of the invention, used to fasten or fix the toner on a print 1. A magnetron 11 to generate microwaves is situated on the left side of the depicted microwave device 20. A circulator 12, also called an isolator, is connected to magnetron 11. A coupling converter 13, which is connected to a resonator chamber 3, in which a microwave field is formed, supplied by magnetron 11, is connected to circulator 12. A coupling opening for coupling the microwave radiation into resonator chamber 3 is situated between the coupling converter 13 and the resonator chamber 3. The coupling opening is preferably situated on the bottom of resonator chamber 3. A water load device, subsequently water load 16, which is connected to circulator 12, is also provided. A power source, hereafter voltage source 15, supplies the magnetron 11 with electrical power, and the voltage source 15 is connected to the water load 16 and coupling converter 13. The coupling converter 13 serves for inductive tuning of the magnetron 11 to resonator chamber 3. The microwave power delivered by magnetron 11 is constant and a change in microwave power of microwave device 20 is essentially not prescribed. The magnetron 11 is preferably arranged such that it has no device to change the microwave power. The service life of magnetron 11 is significantly increased by retention of the delivered power, since it has been found that switching processes in magnetron 11 adversely affect its service life.

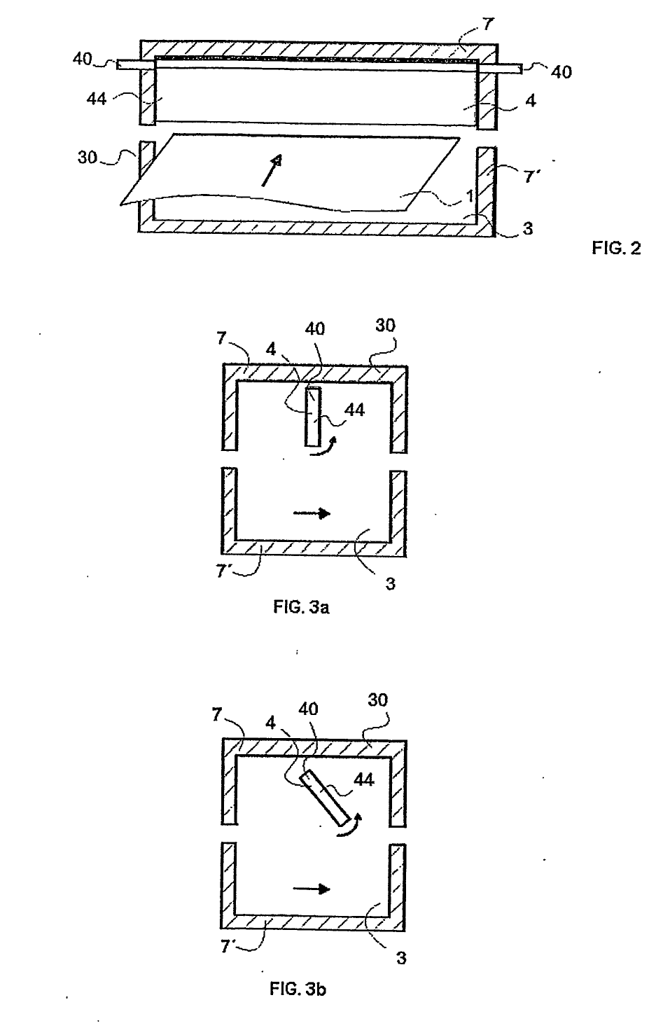

FIG. 2 shows a section of a resonator chamber 3 of a microwave device 20, viewed from the front. The resonator chamber 3 includes a first part 7 and a second part 7′, configured to be trough-like, and whose openings are aligned opposite each other. A free space, through which a print 1 is passed in the direction of the arrow according to FIG. 2, is formed between the first part 7 and the second part 7′ of resonator chamber 3. Holes are formed in the opposite side walls in the first part 7 of resonator chamber 3, through which a rod 40 extends. Rod 40 is rotatable around its axis in the holes of resonator chamber 3. An element 4 is situated essentially in the interior of resonator chamber 3 and includes a blade 44, the blade being a rectangular plate fastened to rod 40. Blade 44 of element 4 extends from one side wall to the opposite side wall of resonator chamber 3. Element 4 in this case is polytetrafluoroethylene (PTFE), known under the trade name Teflon. Rod 40 of element 4, as an alternative, can engage in another opening of resonator chamber 3. The geometry of resonator chamber 3 is preferably laid out such that a standing microwave is expressed in resonator chamber 3. By rotating rod 40, the blade 44 fastened to rod 40 is pivoted in resonator chamber 3. Because of this, the microwave power in resonator chamber 3 of the microwave device 20 is varied and the temperature of the print 1 or paper, upon passing through microwave device 20, is varied by this from the absorption of microwave energy and conversion of the microwave energy to heat energy. The fixing temperature in the resonator chamber 3, which dictates the fixing process, is varied by pivoting blade 44.

A schematic view of element 4 in resonator chamber 3 is shown in the side views of FIGS. 3a and 3b, in which the blade 44 of element 4 is first situated vertically in resonator chamber 3, as according to FIG. 3a, and then, after rotation of rod 40, is pivoted by an angle, as according to FIG. 3b. In this way, the varying paper or print temperature, at different paper or print weights during fixing of the toner, is taken into account by varying the microwave power and fixing temperature for different requirements. At a constant delivered power of magnetron 11, by adjusting element 4, a controlled error adjustment of the output impedance of magnetron 11 to the input impedance of the resonator chamber 3 can be achieved. By this controlled error adjustment, only part of the delivered power of magnetron 11 is available in resonator chamber 3. The remaining part of the delivered power of magnetron 11 is discarded in order to increase its service life. The print 1 is heated to the desired fixing temperature on this account and damage from an unduly high fixing temperature is ruled out. The microwave power not required for heating is reflected back to voltage source 15, deflected by circulator 12 into water load 16, and there is converted to heat.

Since the total delivered power of magnetron 11 is available in resonator chamber 3, the maximum microwave power of the largest required heating power for print 1 corresponds to the highest basis weight. Movement of element 4 finally means that the fixing temperature is adapted to the corresponding print 1 in varying paper or print basis weights without increasing the power supply to the microwave device 20 from voltage source 15. During a change in print 1, for example, from a basis weight of 135 g/m² to a print 1 with a basis weight of 300 g/m², element 4 is pivoted, so that the microwave power in resonator chamber 3 is varied, with the same fixing result being achieved at a basis weight of 135 g/m² as at a basis weight of 300 g/m². Without the pivoting of element 4, the temperature for fixing the toner, the fixing temperature, remains unchanged on print 1. During a change in print 1, the temperature, in this case, is unsuitable. In order to vary the microwave power without element 4, it is necessary to change the output power of voltage source 15. For example, the output power of magnetron 11, for a temperature increase on print 1 from 105° C. to 115° C. and at a speed of the print 1 of 30 cm/s, is increased from 1750 W to 1950 W. In contrast to this, in the embodiment of the invention, no change in the output power of magnetron 11 and ultimately the voltage source 15 supplying it is carried out; instead, blade 44 of element 4 is pivoted from an angle position of 10° relative to the perpendicular to an angle position of 16°, in which the temperature of print 1 is raised accordingly, from 105° C. to 115° C. A switching process in magnetron 11 is thus eliminated. The control and regulation demands for microwave device 20 are limited, since no quantity is controlled, other than the adjustment of element 4.

Generally, in view of the large variety of prints 1 or image carriers, an adjustment of microwave device 20 with respect to the prints 1 is necessary. The microwave device 20 is primarily adjusted as a function of the weight and moisture content of print 1. Allocation tables are set up, which clearly assign a specific position of element 4, clearly and precisely to a specific basis weight of a print 1, as a function of the power on microwave device 20 and the speed with which the print 1 is moved through the resonator chamber 3, so that the toner is appropriately fixed on print 1. The basis weight of print 1 is generally known in the control device of the printer, especially in digital printers, in which different prints 1 with different weights are printed in rapid succession. Element 4 is preferably moved by an appropriate control as a function of the data outputs of the allocation table. For specific embodiments of the invention, stepper motors can be advantageously used, which rotate bar 40, during which blade 44 is pivoted. Another possibility for movement of element 4 is provided by, controlling a magnet coupled to element 4, which, is driven-electrically and moves element 4. By moving element 4, the microwave power in resonator chamber 3 is always adjusted, so that the heating of print 1 and the toner situated on it occurs in an appropriate manner for fixing of the toner on print 1, while power delivered to the magnetron 11 is constant.

One embodiment concerns the case in which the print 1 enters the resonator chamber 3 or emerges from it, in which case hampered fixing conditions result, in comparison with endless or web-like prints 1, in which the weight of the print 1 is constant for a long time in resonator chamber 3, as well as the applicator. In sheet-like prints 1 or image carriers, the weight of the print 1 in the resonator chamber 3 changes with each edge of an individual sheet of print 1 entering or emerging from it. Upon entry and during the emergence of print 1, the print 1 does not extend fully through resonator chamber 3. The fixing temperature of the microwave device 20, however, is tuned (adjusted) by the fact that print 1 fully extends to resonator chamber 3, i.e., to the weight of the print 1 in this case. On entry and emergency of print 1 from resonator chamber 3 of microwave device 20, the effective weight of print 1, however, in resonator chamber 3 is smaller than in the case, in which print 1 extends fully through resonator chamber 3. This reduced effective weight of print 1 in resonator chamber 3 means that the fixing temperature in resonator chamber 3 is not suitable, and the front edge and the rear edge of print 1 are not heated to temperatures appropriate for fixing of the toner. To solve this problem, it is proposed that the position of element 4 be changed as a function of the position of print 1 in the resonator chamber 3. Upon entry and emergence of print 1, the element 4, controlled by a stepper motor, assumes the position that leads to a first microwave power in resonator chamber 3. When the print 1 extends fully through resonator chamber 3 from one side surface 9 to the opposite side surface 9′, element 4 changes position, which leads to a different microwave power in resonator chamber 3. The positions of element 4 are independent of the resonance state of the microwave field in resonator chamber 3; in all positions of element 4, the microwave field can be formed without resonance. The position of print 1 can be determined by sensors in resonator chamber 3, which, for example, detect the front edge of the print 1. From knowledge of the position of the front edge of print 1, it can be determined by the speed of print 1 whether the print 1 is entering or emerging from the resonator chamber 3, so that appropriate control of the position of element 4 is made possible.

The first position of element 4 in this example is set up for heating a specific print 1 with a basis weight of 300 g/cm². If the printer, after fixing print 1 with a basis weight of 300 g/m², is operated with another print 1, for example, with a print 1 having a basis weight of 135 g/m², sufficient heating is not achieved with the original position of element 4, for example, according to FIG. 3a. If the microwave device 20 in the printing machine is supplied another print 1 with a basis weight of 135 g/m², a stepper motor causes the rotation of element 4 into a second position, for example, according to FIG. 3b, as shown by the arrow. In the second position of element 4, the print 1, with a basis weight of 135 g/m², is appropriately heated, in order to fix the toner.

In a microwave device 20 with a constant output power of magnetron 11, the difference in the required heating power of the fixing temperature in different prints 1 is often so large that the set heating power for a print 1 that requires a high heating power is so high that a print 1 that requires a smaller heating power is damaged. A case is conceivable in which unduly high heating in resonator chamber 3 is present, because of an error function of element 4 or the control device at a constant output power of magnetron 11. To avoid damage to print 1 in this case, it is proposed, as an expansion of microwave device 20, that it does not provide constant power, as described above, but, for example, two or more power steps instead. These are dimensioned and chosen by regulating the microwave device 20, so that the maximum delivered power in the corresponding power step does not damage the print 1 that requires the smallest heating power in this power step. The service life of magnetron 11 is reduced in comparison with the constant-voltage source 15, but the control of magnetron 11, however, is simplified in comparison with frequent changing of the microwave power delivered to magnetron 11. A microwave device 20 with two switching steps to adjust the delivered power of magnetron 11 is advantageously provided, in which the low switching step corresponds to about 75% of the maximum output power of magnetron 11 or 75% of all the used prints 1, depending on which output power is lower. This solution permits simple control of magnetron 11 at a largely constant output power, with a high safety against damage to print 1.

1. Method for fixing toner on a print (1) by heating by a power source including microwave device (20), in which print (1) is passed through a resonator chamber (3) of microwave device (20), the method comprising setting the microwave power in resonator chamber (3) by at least one element (4) in the resonator chamber (3), and maintaining delivered power by the power source to microwave device (20) constant.

2. Method for fixing toner to a print (1) by heating to a desired fixing temperature by a microwave device (20), including a power source, in which the print (1) is passed through a resonator chamber (3) of the microwave device (20), the method comprising: setting the fixing temperature by an element (4), while maintaining a constant power level of the power source.

3. Method according to claim 2, wherein the fixing temperature is set as a function of the speed of print (1).

4. Method according to claim 2, wherein the microwave power or fixing temperature is set as a function of the weight of print (1).

5. Method according to claim 2, wherein the microwave power or fixing temperature is set as a function of the moisture content of print (1).

6. Method according to claim 2, wherein the microwave power or fixing temperature is set as a function of the position of print, i.e., whether the print (1) fully, or partially, extends through resonator chamber (3).

7. Method according to claim 1, wherein element (4) is controlled in steps in resonator chamber (3).

8. Method according to claim 7, wherein element (4) assumes different angle positions in resonator chamber (3).

9. Method according to claim 1, wherein excess microwave energy of the microwave device (20) is fed to a water load device.

10. Microwave device (20) for the fixing of toner on a print (1) comprising: a resonator chamber (3) in which a microwave field is formed, an element (4) in said resonator chamber (3) to adjust the microwave power and/or fixing temperature, and a constant-power source for microwave device (20).

11. Microwave device (20) according to claim 10, wherein said element (4) is a rectangular plate or blade (44), made of essentially dielectric material, pivotable by a certain angle, said blade extending from one wall to an opposed wall of the resonator chamber (3).
